(19) United States
(12) Patent Application Publication
(10) Pub. No.: US 2010/0026645 A1
(43) Pub. Date: Feb. 4, 2010

(54) TOUCH DISPLAY PANEL

(76) Inventors: Sang-Hoon Yim, Suwon-si (KR); Jong-Han Rhee, Suwon-si (KR)

Correspondence Address: CHRISTIE, PARKER & HALE, LLP, PO BOX 7068, PASADENA, CA, 91109-7068, US

(21) Appl. No.: 12/502,143

(22) Filed: Jul. 13, 2009

Related U.S. Application Data
(60) Provisional application No. 61/084,584, filed on Jul. 29, 2008.

(51) Int. Cl. G06F 3/041

(52) U.S. Cl. 345/173; 345/175

(57) ABSTRACT

A touch display panel assembly is provided. The touch display panel assembly includes a display panel having a display surface on a side of the display panel for emitting light, a touch light detector at a periphery of the display panel for detecting the emitted light and having an iris that faces in a direction substantially normal to the display surface for passing the emitted light into the touch light detector, and a light guide above the iris for guiding the emitted light from the display surface to the iris and into the touch light detector. The touch display panel assembly has an improved viewing angle and can be made thinner as compared to conventional touch display panels due to the improved features of the touch light detector.

### CROSS-REFERENCE TO RELATED PATENT APPLICATION

This application claims priority to and the benefit of U.S. Provisional Patent Application No. 61/084,584, filed on Jul. 29, 2008, the entire content of which is incorporated herein by reference.

### BACKGROUND OF THE INVENTION

1. Field of the Invention

The present invention relates to a touch display panel, and more particularly, to a touch display panel having an improved light detector that recognizes a touch function by detecting a change of light.

2. Description of the Related Art

A touch panel can be an infrared ray, resistance film, electrostatic capacitive, ultrasonic wave, or pressure sensor type touch panel. An optical type touch panel, such as an infrared ray type touch panel, can be used for large screens, such as a plasma display panel.

An existing touch display panel has touch light detectors that include two reflection mirrors, which respectively extend along the edges of a flat display panel orthogonal to each other. The reflection mirrors have reflection planes facing toward a display unit side of the flat display panel, and are attached at a 45 degree angle with respect to an inner side of the display panel. The touch light detector further includes two light receivers, which face the two reflection mirrors on the opposite edges that face the edges where the two reflection mirrors are attached. Accordingly, the two light receivers and the reflection mirrors protrude from the surface of the flat display panel, thereby increasing the entire thickness of the flat display panel assembly.

### SUMMARY OF THE INVENTION

An aspect of an embodiment of the present invention is directed toward a touch display panel having improved features in detecting a user's touch function by detecting changes of light.

In one embodiment, the touch display panel includes a display panel having a display surface on a side of the display panel for emitting light, a touch light detector at a periphery of the display panel for detecting the emitted light and having an iris for allowing the emitted light to pass into the touch light detector, and a light guide above the iris for guiding the emitted light from the display surface to the iris and into the touch light detector. The iris faces in a direction substantially normal to the display surface.

In one embodiment, the light guide includes a reflection mirror having a reflection surface with an incline to reflect the light from the display surface toward the iris. The reflection surface may be a curved surface, or more particularly, can be a convex mirror. The light guide may further include a visible light blocking filter and a support coupled to the reflection mirror and the touch light detector to maintain an inclination angle (θ₁) between the reflection surface and the display surface.

In certain embodiments, the reflection mirror has a slit with one horizontal stripe or multiple stripes, where a first stripe extends in a first direction, and a second stripe extends in a second direction crossing the first direction.

The touch display panel may further include a bracket for coupling the touch light detector to a chassis base at the periphery of the display panel, and the touch light detector is between the bracket and the reflection mirror.

In one embodiment, the light guide is a prism having a density value to direct the light from the display surface to the iris. The density value of the prism is a value in which the prism provides a substantially total reflection of the light. The prism may be placed in position such that it completely or substantially covers the iris. In one embodiment, the prism has a concave surface facing toward the display surface. The prism may be attached to the periphery of the iris by an adhesive. In one embodiment, the adhesive has a density value substantially identical to that of the prism and is between the prism and the iris and covering the iris.

In one embodiment, the touch display panel includes at least two touch light detectors, each located at a corner of the display panel. The touch light detector may include a housing, the iris being in the housing, and a lens located inside the housing. The iris may be smaller in size than the lens and the lens may have a viewing angle of about 65°. In one embodiment, the light guide is configured to increase the viewing angle of the lens to about 90°.

According to another embodiment, the display panel includes a first substrate, a second substrate spaced from and facing the first substrate, a phosphor between the first substrate and the second substrate, and a plurality of discharge electrodes for generating vacuum ultraviolet rays to excite a phosphor material of the phosphor layer. When the display panel emits an infrared ray(s), the touch light detector is configured to detect a variation of the emitted infrared ray(s). In one embodiment, the touch light detector further includes an infrared transmission filter in a light path between the display surface and a lens of the touch light detector.

Another aspect of an embodiment of the present invention is directed toward a plasma display device, which includes the display panel, and the touch light detector. In one embodiment, the plasma display device further includes a front cabinet and a back cover for containing the display panel. The front cabinet may have a portion covering the touch light detector and the light guide.

In certain embodiments, the touch display panels of the present invention are thin or have a small or minimal thickness by reducing or minimizing the thickness of the touch light detector. The touch display panel according to various embodiments of the present invention also has an improved touch light detector with a wider view angle (or wider viewing angle).

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an exploded perspective view of a plasma display device, according to an embodiment of the present invention;

FIG. 2 is an enlarged perspective view of the touch light detector of FIG. 1;

FIG. 3 is a cross-sectional view of the touch light detector of FIG. 1;

FIG. 4 is a plan view illustrating a mechanism of detecting lights of a touch light detector according to an embodiment of the present invention;

FIG. 5A is an infrared ray graph illustrating a detection of an infrared ray(s) in an area X using a negative method;

FIG. 5B is an infrared ray graph illustrating a detection of an infrared ray(s) in an area Z using a negative method;

FIG. 5C is an infrared ray graph illustrating a detection of an infrared ray(s) in an area Y using a negative method;

FIG. 5D is an infrared ray graph illustrating a detection of an infrared ray(s) in an area X using a positive method;

FIG. 5E is an infrared ray graph illustrating a detection of an infrared ray(s) in an area Z using a positive method;

FIG. 5F is an infrared ray graph illustrating a detection of an infrared ray(s) in an area Y using a positive method;

FIG. 6 is a plan view of a reflection mirror according to an embodiment of the present invention;

FIG. 7 is a plan view of another reflection mirror according to another embodiment of the present invention;

FIG. 8 is a plan view of another reflection mirror according to yet another embodiment of the present invention;

FIG. 9 is an enlarged perspective view of a touch light detector according to an embodiment of the present invention; and

FIG. 10 is a cross-sectional view of the touch light detector of FIG. 9.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being “on” another element, it can be directly on another element or be indirectly on another element with one or more intervening elements interposed therebetween. Like reference numerals designate like elements throughout the specification.

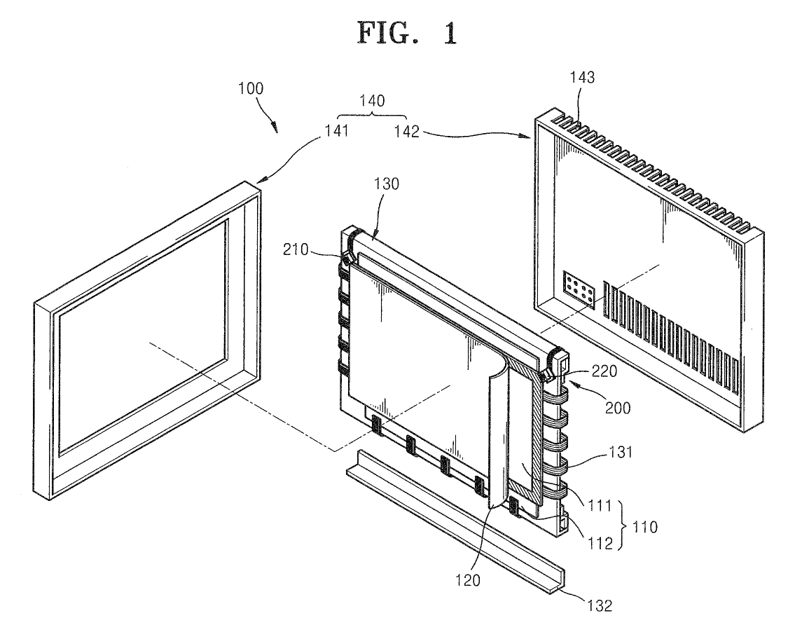

Referring to FIG. 1, a plasma display device 100 includes a touch display panel, a filter assembly 120 attached in front of the touch display panel, a chassis base (or chassis base assembly) 130 installed at the back of the touch display panel, and a case 140 containing the touch display panel, the filter assembly 120, and the chassis base 130. In one embodiment, the touch display panel includes a display panel (or panel assembly) 110, a touch light detector 200, and a light guide to direct light into the touch light detector 200, all of which shall be described in further detail below.

The display panel 110 includes a first substrate 111 and a second substrate 112 facing the first substrate 111. A sealing member, such as frit glass, is coated on inner facing edges of the first and second substrates 111 and 112, thereby sealing a discharge space between the first and second substrates 111 and 112.

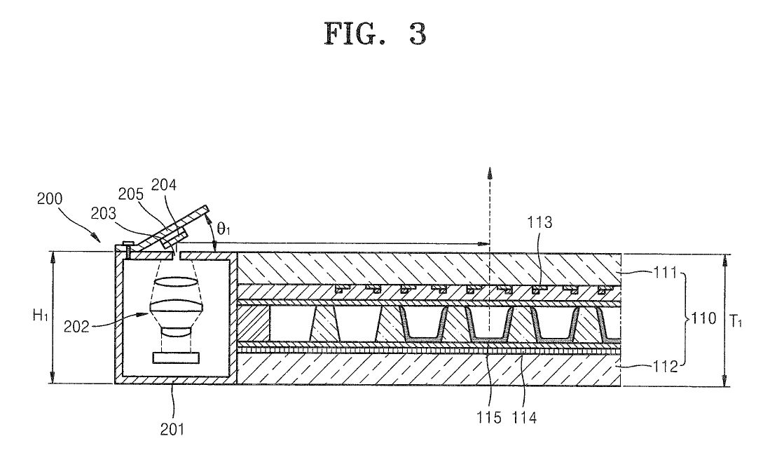

Referring also to FIG. 3, the plasma display device 100 exhibits different numerical and graphical displays by gas and phosphor excitation. In one embodiment, the gas and phosphor excitation process is achieved by injecting and sealing the discharge gas in the display panel 110, where a plurality of discharge electrodes 113 and 114 are disposed, applying a discharge voltage to the plurality of discharge electrodes 113 and 114 (in FIG. 3), and exciting a phosphor material of a phosphor layer 115 by using a vacuum ultraviolet ray generated by the applied discharge voltage. The plasma display device 100 emits infrared ray(s) (dotted line) along with ultraviolet ray(s) during gas discharge.

Referring back to FIG. 1, the filter assembly 120 is directly attached to the front surface of the first substrate 111, which is a substrate that allows visible light to pass through. The filter assembly 120 includes a plurality of films stacked on one another in order to reduce or prevent reflection of external lights, neon radiations, and/or electromagnetic waves generated from the display panel 110.

In addition, the chassis base 130 includes a base attached to the back of the display panel 110 by an adhesive member, a circuit board attached to the back of the base, and a circuit device mounted on the circuit board. A terminal of a signal transmitter 131, such as a flexible printed cable is electrically connected to the circuit board, and another terminal of the signal transmitter 131 is electrically connected to terminals of each of the discharge electrodes 113 and 114 of the display panel 110. A cover plate 132 can further be included and installed below the chassis base 130 to protect any part where the signal transmitter 131 is installed.

The case 140 includes a front cabinet 141, which is installed in front of the filter assembly 120, and a back cover 142, which is installed at the back of the chassis base 130. A plurality of air through-holes 143 are formed in the top and bottom of the back cover 142.

In one embodiment, the plasma display device 100 includes a touch light detector 200 (e.g., an infrared light sensor) composed of a plurality of touch light detectors 210 and 220. The touch light detector 210, 220, which detects changes in infrared rays, is installed at an edge of the display panel 110.

The infrared rays may be generated from an infrared ray generating apparatus or the plasma display device 100, but is not limited thereto. In one embodiment, the infrared ray is generated from the plasma display device 100 itself.

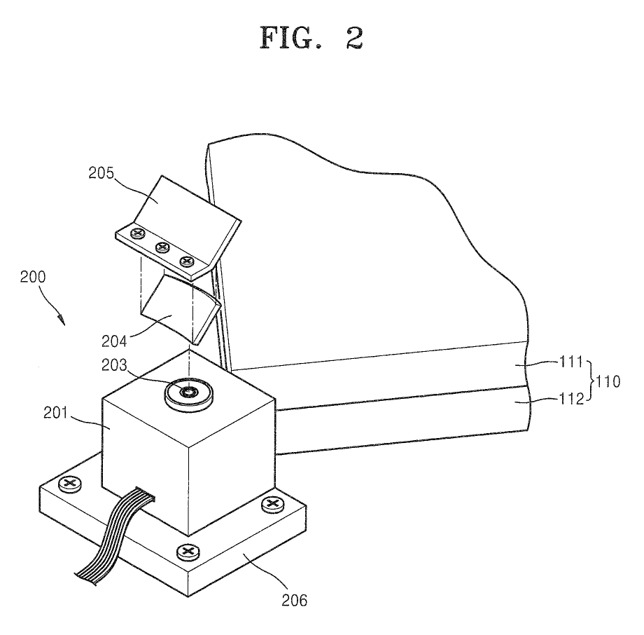

Referring to FIGS. 2 and 3, the touch light detector 200 (or a part of the touch light detector 200) is installed at a corner of the display panel 110. The touch light detector 200 includes a sensor housing unit 201 and a lens 202 installed inside the sensor housing unit 201. The touch light detector 200 photographs objects via an iris 203 formed in front of the sensor housing unit 201. The iris 203, which allows light to pass, is generally smaller than a lens and a charged-coupled device (CCD). In one embodiment, light rays are allowed to pass through the iris 203 by a small mirror adjacently located to the iris 203. The mirror 204 changes the direction of the light rays, thereby passing them through the iris 203.

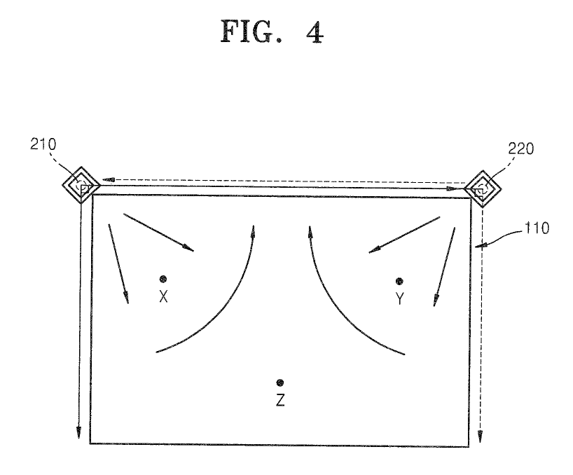

Referring to FIG. 4, there is shown the first touch light detector 210, which is installed at an upper corner of the display panel 110, and the second touch light detector 220, which is installed at another upper corner. Alternatively, the touch light detectors 210 and 220 can be installed at the lower corners of the display panel 110. The touch light detector 210, 220 may be provided in any form so long as it is installed at a corner of the display panel.

The touch light detectors 210 and 220 may include one or more features of the touch light detector 200. In one embodiment, the touch light detectors 210 and/or 220 are the same as the touch light detector 200.

Referring back to FIG. 3, in an embodiment, the iris 203 is formed to face in a direction normal or substantially normal to a screen of the display panel 110. Accordingly, the touch light detector 200 cannot by itself detect any infrared rays emitted from the display panel 110.

To remedy this, a light guide, such as a reflection mirror 204, is installed above the iris 203 to direct and/or reflect infrared rays emitted from the surface of the display panel 110.

Here, since the touch light detector 200 is installed at the corner of the display panel 110, instead of above the display panel 110, a height H1 of the touch light detector 200 may be substantially the same as the thickness T1 of the display panel 110. Moreover, since the size of the iris 203 is small, a small size reflection mirror 204 can be used. In this way, the overall thickness of the plasma display device 100, which includes the display panel 110 and the touch light detector(s), can be reduced or minimized.

A view angle (or viewing angle) of the touch light detector 200 is generally 90°, but since the view angle of a conventional lens is generally 65°, the reflection mirror 204 as previously described, may be modified, or an additional lens can be used to gain an additional view angle of 25°.

The reflection mirror 204 may have a curved surface, like a convex mirror. A camera lens may include a filter (e.g., and infrared transmitter filter) that allows only infrared rays to pass through and blocks other lights, thereby protecting the touch light detector 200 from any camera malfunction that is caused by visible light or the like.

Referring back to FIG. 2, a reflection supporter 205 is installed at the back of the reflection mirror 204 and fixed in front of the sensor housing unit 201. The reflection supporter 205 may have the same inclination angle as the reflection mirror 204, so that the reflection mirror 204 can maintain a set or predetermined angle θ₁ with the iris 203.

A bracket 206 is installed below the sensor housing unit 201, so that the light detector 200 can be mounted in front of the chassis base 130.

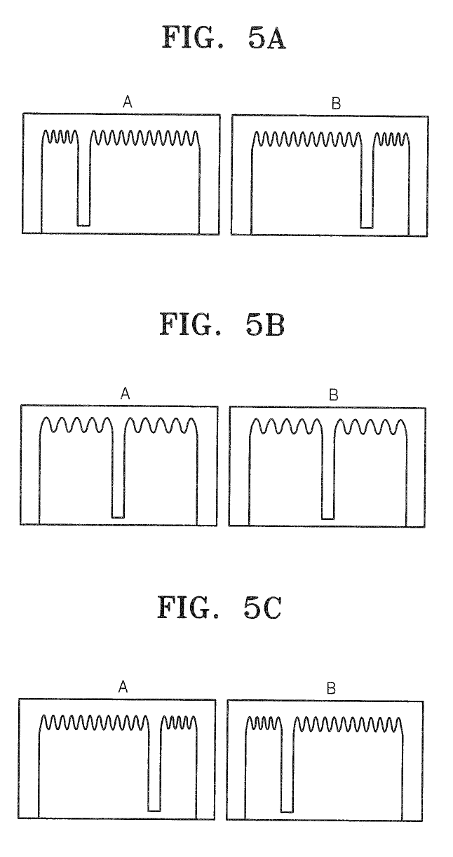

Operations of the light detector 200 will now be described with reference to FIGS. 4 and 5A through 5F.

When the plasma display device 100 of FIG. 1 is activated, infrared rays are emitted from the surface of the display panel 110. When a user touches areas X, Y, and Z of the surface of the display panel 110, and blocks certain pathway of lights, an infrared ray graph can be generated based on the changes in the amount of light detected by the first and second touch light detectors 210 and 220.

In other words, when each of the areas X, Y, and Z is touched, each of the first touch light detector 210 installed at the left upper corner of the display panel 110 and the second touch light detector 220 installed at the right upper corner of the display panel 110 detects the infrared rays in the touched areas X, Y, and Z via the iris 203 through the reflection mirror 204.

The detected infrared rays are then used to generate graphs A and B, where the first infrared ray graph A is generated from the infrared rays detected by the first touch light detector 210, and the second infrared ray graph B is generated from the infrared rays detected by the second touch light detector 220. Information generated from the first and second touch light detectors 210 and 220 is used to calculate the locations of the touched areas X, Y, and Z using an algorithm based on the angles of the touched areas X, Y, and Z, and the distance between the first and second touch light detectors 210 and 220.

For example, as illustrated in FIGS. 5A through 5C, a negative method may be used, where the location is calculated by detecting whether the amount of light decreased in the touched area X, Y, or Z. Alternatively, as illustrated in FIGS. 5D through 5F, a positive method may be used, where the location is calculated by detecting whether the amount of light increased in the touched area X, Y, or Z. In the present invention, any of these two methods can be used; however, the method of calculating the location is not limited thereto.

In various embodiments, the display panel 110 includes the first and second touch light detectors 210 and 220 to achieve a viewing angle of 90° (arrows in a dotted line and a solid line) because each of the first and second touch light detectors 210 and 220 has the reflection mirror 204 installed above the iris 203. As such, the touch light detectors 210 and 220 can cover the entire area of the display panel 110.

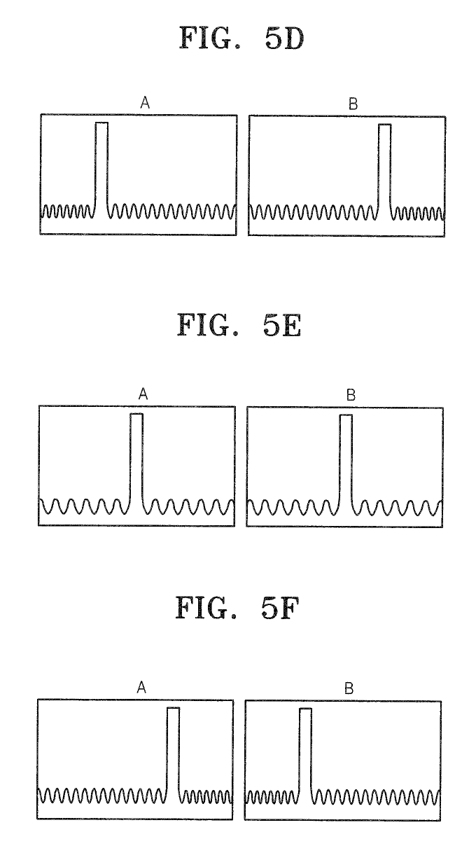

FIGS. 6 through 8 are plan views of modified examples of the reflection mirror 204.

Referring to FIG. 6, a reflection mirror 600 includes a slit 601. In one embodiment, the slit 601 is formed to reduce or prevent unnecessary light from entering and can also be used to facilitate the installation of the reflection mirror 600. The slit 601 may be a strip formed in a horizontal direction at the center of the reflection mirror 600. The remaining area 602 may be covered with tapes or other materials using a coating process. In one embodiment, the slit 601 is formed on the front surface of the reflection mirror 600 that faces the display panel 110.

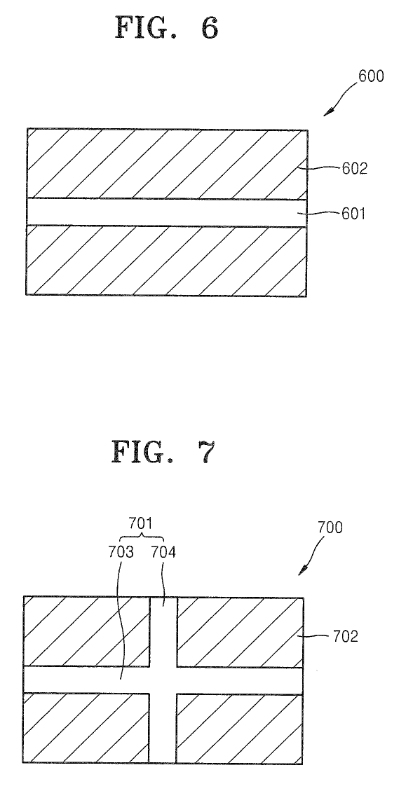

Referring to FIG. 7, a reflection mirror 700 includes a slit 701, which includes a first stripe 703 crossing the center of the reflection mirror 700 in a horizontal direction, and a second stripe 704 crossing the center of the reflection mirror 700 in a vertical direction. The first and second stripes 703 and 704 intersect each other. The remaining area 702 may be covered with tapes or other materials using a coating process. In one embodiment, the slit 701 is formed on the front surface of the reflection mirror 700 that faces the display panel 110.

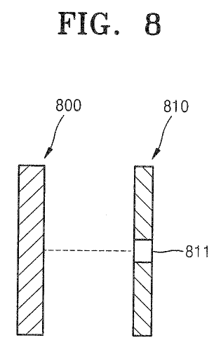

Referring to FIG. 8, a slit member 810 is arranged in front of a reflection mirror 800. Unlike the reflection mirrors 600 and 700, the slit member 810 is separately arranged in front of the reflection mirror 800. The slit member 810 includes a slit 811 in an area corresponding to the center of the reflection mirror 800. The slit member 810 may be attached to the front surface of the reflection mirror 800 that faces the display panel 110, or may be spaced a distance away from the front surface of the reflection mirror 800.

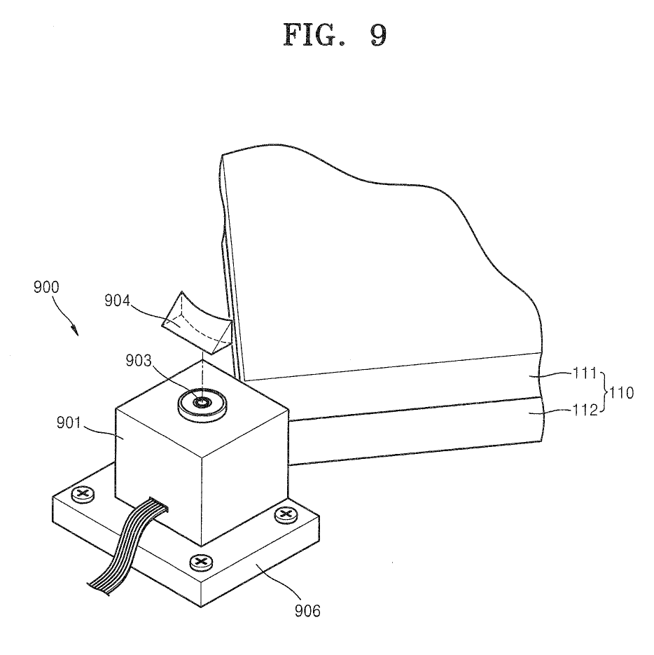

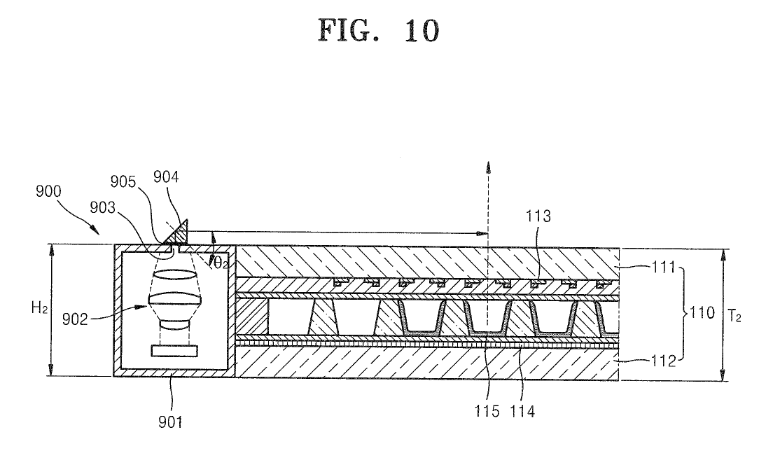

FIG. 9 is an enlarged perspective view of a touch light detector 900 according to another embodiment of the present invention, and FIG. 10 is a cross-sectional view of the touch light detector 900 of FIG. 9.

Referring to FIGS. 9 and 10, a sensor housing unit 901 is provided for the touch light detector 900, and a lens 902 is installed inside the sensor housing unit 901. The touch light detector 900 can photograph objects through an iris 903 formed in front of the sensor housing unit 901. The touch light detector 900 can also photograph and/or detect light rays from the display panel 110 by changing their directions using a light guide, such as a small prism 904 located adjacent to the iris 903, so that the light rays can pass through the iris 903.

The iris 903 is formed facing in a direction normal or substantially normal to a screen of the display panel 110 at a corner of the display panel 110. As such, the touch light detector 900 cannot by itself detect any infrared rays emitted from the display panel 110. Therefore, in one embodiment, the prism 904 is installed above the iris 903 to detect infrared rays emitted from the surface of the display panel 110. Since the prism 904 has a concave curved surface, the view angle (or viewing angle) of the iris 903 increases. The prism 904 may be attached to the top of the iris 903 by an adhesive 905 (FIG. 10). In one embodiment, the prism 904 may be attached to the periphery of the iris by an adhesive. In another embodiment, the adhesive has a density value substantially identical to that of the prism and is between the prism and the iris and covering the iris.

Since the touch light detector 900 is installed at the corner of the display panel 110, instead of the top surface of the display panel 110, a height H2 of the touch light detector 900 can be substantially equal to the thickness T2 of the display panel 110. Also, since the size of the iris 903 is small, the prism 904 having a small size can be used, and thus the entire thickness of the display panel 110 and the touch light detector can be reduced or minimized.

The prism 904 may be formed of a material having a density value that provides a total reflection of light at a threshold angle (θ₂) of 45°. Nonlimiting examples of suitable materials include glass or high density plastic. Alternatively, the prism 904 may be formed of a material (or formed with a visible light block filter) that only allows infrared rays to pass through and block other lights. Accordingly, camera malfunctions that are caused by visible lights can be reduced or prevented.

An equation of a density and a threshold angle of a material, such as high density plastic and glass, is as follows:

θc=arcsin(n2/n1)

Here, n1 denotes the density of air, n2 denotes the density of glass or a material such as high density plastic, and θc denotes a threshold angle.

For example, when the density of the prism 904 formed of high density plastic is 1.41, total reflection is possible when the threshold angle is 45°.

Referring back to FIG. 9, a bracket 906 is installed below the sensor housing unit 901, and thus the touch light detector 900 can be installed on the front surface of the chassis base 130 of FIG. 1.

As described above, a touch screen panel of an embodiment of the present invention can provide the following. First, manufacturing cost can be reduced because the touch function can be performed by using and sensing light of a display panel.

Second, the thickness of the display panel can be reduced because the sensing unit or touch light detector is installed at the corner of the display panel.

Third, a view angle (or viewing angle) is increased by installing a modified reflection mirror or a prism.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A touch display panel comprising:
a display panel having a display surface on a side of the display panel for emitting light;
a touch light detector at a periphery of the display panel for detecting the emitted light and having an iris for allowing the emitted light to pass into the touch light detector, the iris facing in a direction substantially normal to the display surface; and
a light guide above the iris for guiding the emitted light from the display surface to the iris and into the touch light detector.

2. The touch display panel of claim 1, wherein the touch light detector is an infrared light sensor for sensing infrared light generated from the display panel.

3. The touch display panel of claim 1, wherein the light guide comprises a reflection mirror having a reflection surface with an incline to reflect the light from the display surface toward the iris.

4. The touch display panel of claim 3, wherein the reflection surface is a curved surface.

5. The touch display panel of claim 3, wherein the reflection mirror is a convex mirror.

6. The touch display panel of claim 3, further comprising a support coupled to the reflection mirror and the touch light detector to maintain an inclination angle (θ₁) between the reflection surface and the display surface.

7. The touch display panel of claim 3, wherein the reflection mirror has a slit.

8. The touch display panel of claim 3, wherein the reflection mirror has a slit comprising a first stripe extending in a first direction, and a second stripe extending in a second direction crossing the first direction.

9. The touch display panel of claim 3, further comprising a bracket for coupling the touch light detector to a chassis base, the touch light detector being between the bracket and the reflection mirror.

10. The touch display panel of claim 1, wherein the light guide comprises a prism having a density value to direct the light from the display surface to the iris.

11. The touch display panel of claim 10, wherein the density value of the prism is a value in which the prism provides a substantially total reflection of the light.

12. The touch display panel of claim 10, wherein the prism covers the iris.

13. The touch display panel of claim 10, wherein the prism has a concave surface facing toward the display surface.

14. The touch display panel of claim 10, further comprising an adhesive between the prism and a periphery of the iris.

15. The touch display panel of claim 10, further comprising an adhesive having a density value substantially identical to that of the prism, the adhesive being between the prism and the iris and covering the iris.

16. The touch display panel of claim 10, further comprising a bracket for coupling the touch light detector to a chassis base, the touch light detector being between the bracket and the prism.

17. The touch display panel of claim 1, wherein the touch light detector is at a corner of the display panel.

18. The touch display panel of claim 1, wherein the touch light detector comprises at least two touch light detectors, and wherein the at least two touch light detectors are at respective corners of the display panel.

19. The touch display panel of claim 1, wherein the touch light detector comprises:
a housing, the iris being in the housing; and
a lens located inside the housing.

20. The touch display panel of claim 19, wherein the iris is smaller in size than the lens.

21. The touch display panel of claim 19, wherein the lens has a viewing angle of about 65°, and wherein the light guide is configured to increase the viewing angle of the lens to about 90°.

22. The touch display panel of claim 1, wherein the light guide has a sloped face to guide the emitted light from the display surface toward the iris.

23. The touch display panel of claim 1, wherein the display panel comprises:
a first substrate;
a second substrate spaced from and facing the first substrate;
a phosphor layer between the first substrate and the second substrate; and
a plurality of discharge electrodes for generating vacuum ultraviolet rays to excite a phosphor material of the phosphor layer,
wherein the display panel emits an infrared ray, and
wherein the touch light detector is configured to sense a variation of the emitted infrared ray.

24. The touch display panel of claim 1, further comprising an infrared transmission filter in a light path between the display surface and a lens of the touch light detector.

25. The touch display panel of claim 1, wherein the light guide comprises a visible light blocking filter.

26. A plasma display device comprising:
a display panel comprising:
a first substrate,
a second substrate spaced from and facing the first substrate,
a phosphor layer between the first substrate and the second substrate, and
a plurality of discharge electrodes for generating vacuum ultraviolet rays to excite a phosphor material of the phosphor layer to emit light through a display surface on a side of the display panel;
a touch light detector at a periphery of the display panel for detecting the emitted light and having an iris for allowing the emitted light to pass into the touch light detector, the iris facing in a direction substantially normal to the display surface; and
a light guide above the iris for guiding the emitted light to the iris and into the touch light detector.

27. The plasma display device of claim 26, further comprising:
a front cabinet and a back cover containing the display panel, wherein the front cabinet has a portion covering the touch light detector and the light guide.
